(19) United States
(12) Patent Application Publication
(10) Pub. No.: US 2026/0086107 A1
(43) Pub. Date: Mar. 26, 2026

(54) OVER-RANGE SIGNAL RESTORATION AND SIGNAL QUALITY ENHANCEMENT SYSTEM FOR INERTIAL SENSOR

(71) Applicant: Harbin Institute of Technology, Shenzhen (Shenzhen Institute of Science and Technology Innovation,, Shenzhen (CN)

(72) Inventors: Yi ZHAO, Shenzhen (CN); Yifeng WANG, Shenzhen (CN)

(73) Assignee: Harbin Institute of Technology, Shenzhen (Shenzhen Institute of Science and Technology Innovation,, Shenzhen (CN)

(21) Appl. No.: 19/336,746

(22) Filed: Sep. 23, 2025

(30) Foreign Application Priority Data
Sep. 23, 2024 (CN) 202411322457.4

(51) Int. Cl. G01P 15/00

(52) U.S. Cl. CPC G01P 15/00

(57) ABSTRACT

Provided is an over-range signal restoration and signal quality enhancement system for an inertial sensor. The system includes: a signal acquisition module, configured to acquire a high-cost sensor signal and a low-cost sensor signal; a generator GAN_{H→L} and a generator GAN_{L→H} configured to perform conversion between a low-cost sensor signal and a high-cost sensor signal; a modulated Laplacian energy (MLE) module, configured to: inject Laplacian energy into the low-cost sensor signal when the low-cost sensor signal is converted by the generator GAN_{L→H} into a high-cost sensor signal, and inject Laplacian energy to the high-cost sensor signal when the high-cost sensor signal is converted by the generator GAN_{H→L} into a low-cost sensor signal; and an optimal transport supervision (OTS) module, configured to construct an optimal mapping between the feature of the low-cost sensor signal and the feature of the high-cost sensor signal based on an optimal transport theory.

### CROSS REFERENCE TO RELATED APPLICATION

This patent application claims the benefit and priority of Chinese Patent Application No. 202411322457.4, filed with the China National Intellectual Property Administration on Sep. 23, 2024, the disclosure of which is incorporated by reference herein in its entirety as part of the present application.

### TECHNICAL FIELD

This application relates to the field of sensor technologies, and in particular, relates to an over-range signal restoration and signal quality enhancement system for an inertial sensor.

### BACKGROUND

Low-cost accelerometers have become key components in fields such as modern industries, healthcare, and smart devices because of their affordability and wide applicability. However, these sensors are often limited in accuracy and measurement range, and have difficulty in providing precise signals in high-dynamic environments. This may lead to data loss or measurement errors in some critical applications. Therefore, improving the signal quality and expanding the measurement range of low-cost accelerometers has a significantly practical value. A traditional hardware upgrade method can enhance sensor performance to a specific extent, but is limited in adoption in large-scale applications due to high costs. In addition, a generative adversarial network (GAN), as an advanced generative model, can be used to learn distribution characteristics of data and convert low-quality inputs into high-quality outputs. This provides an economical and efficient approach for enhancing signals of the low-cost accelerometer.

However, due to lack of frame-wise paired data between low-cost and high-cost sensor signals, a traditional GAN architecture and a fully supervised training method are not applicable in this scenario.

### SUMMARY

An objective of this application is to provide an over-range signal restoration and signal quality enhancement system for an inertial sensor, to significantly improve reconstruction accuracy and quality of low-cost accelerometer signals through multi-level detail enhancement.

To achieve the above objective, this application provides the following technical solutions.

According to a first aspect, this application provides an over-range signal restoration and signal quality enhancement system for an inertial sensor, including: a generator GAN_{L→H}, a generator GAN_{H→L}, an optimal transport supervision (OTS) module, a modulated Laplacian energy (MLE) module, and a signal acquisition module, where
the signal acquisition module is configured to acquire a high-cost sensor signal and a low-cost sensor signal, where the low-cost sensor signal and the high-cost sensor signal are unpaired or weakly paired;
the generator GAN_{H→L} is configured to convert the high-cost sensor signal into a low-cost sensor signal;
the generator GAN_{L→H} is configured to convert the low-cost sensor signal into a high-cost sensor signal;
the MLE module is configured to: inject Laplacian energy into the low-cost sensor signal when the low-cost sensor signal is converted by the generator GAN_{L→H} into a high-cost sensor signal, and inject Laplacian energy into the high-cost sensor signal when the high-cost sensor signal is converted by the GAN_{H→L} into a low-cost sensor signal, where the Laplacian energy is Laplacian energy of a neural network; and the Laplacian energy is used to adjust Laplacian energy of a model in a generative deep learning architecture; and
the OTS module is configured to: mine, based on an optimal transport theory, potential correlation between unpaired and weakly paired data, and construct, according to the potential correlation, an optimal mapping between a feature of the low-cost sensor signal and a feature of the high-cost sensor signal.

According to specific embodiments provided in this application, this application discloses the following technical effects:

This application provides the over-range signal restoration and signal quality enhancement system for an inertial sensor. The system includes the generator GAN_{L→H}, the generator GAN_{H→L}, the OTS module, the MLE module, and the signal acquisition module. The signal acquisition module is configured to acquire a high-cost sensor signal and a low-cost sensor signal. The generator GAN_{H→L} is configured to convert the high-cost sensor signal into a low-cost sensor signal. The generator GAN_{L→H} is configured to convert the low-cost sensor signal into a high-cost sensor signal. The MLE module is configured to: inject modulated Laplacian energy into the low-cost sensor signal in the signal conversion process of the generator GAN_{L→H}, and inject modulated Laplacian energy into the high-cost sensor signal in the signal conversion process of the generator GAN_{H→L}. The OTS module is configured to establish, based on the optimal transport theory, an optimal mapping relationship between the feature of the low-cost sensor signal and the feature of the high-cost sensor signal. Therefore, in this application, signal quality of the low-cost inertial sensor can effectively enhance without relying on frame-wise paired data.

### BRIEF DESCRIPTION OF THE DRAWINGS

To describe the technical solutions in the embodiments of this application or in the conventional technology more clearly, the following briefly describes the accompanying drawings required for the embodiments. Apparently, the accompanying drawings in the following description show merely some embodiments of this application, and a person of ordinary skill in the art may still derive other accompanying drawings from these accompanying drawings without creative efforts.

FIG. 1 is a structural schematic diagram of a (bidirectional generative architecture) HEROS-GAN framework according to an embodiment of this application;

FIGS. 2A-2B are schematic diagrams of optimal transport supervision according to an embodiment of this application, where FIG. 2A shows element-wise supervision, and FIG. 2B shows optimal transport supervision; and

FIG. 3 is a schematic diagram of modulated Laplacian energy (MLE) according to an embodiment of this application.

### DETAILED DESCRIPTION OF THE EMBODIMENTS

The technical solutions in the embodiments of this application are clearly and completely described below with reference to the drawings in the embodiments of this application. Apparently, the described embodiments are only some rather than all of the embodiments of this application. All other embodiments obtained by a person of ordinary skill in the art based on the embodiments of this application without creative efforts shall fall within the protection scope of this application.

To make the above objectives, features, and advantages of this application more obvious and easier to understand, this application will be further described in detail with reference to the accompanying drawings and specific implementations.

### Embodiment 1

This embodiment provides an over-range signal restoration and signal quality enhancement system for an inertial sensor, including: a generator GAN_{L→H}, a generator GAN_{H→L}, an optimal transport supervision (OTS) module, a modulated Laplacian energy (MLE) module, and a signal acquisition module.

The signal acquisition module is configured to acquire a high-cost sensor signal and a low-cost sensor signal. The low-cost sensor signal and the high-cost sensor signal are unpaired or weakly paired.

The generator GAN_{H→L} is configured to convert the high-cost sensor signal into a low-cost sensor signal.

The generator GAN_{L→H} is configured to convert the low-cost sensor signal into a high-cost sensor signal.

The MLE module is configured to: inject Laplacian energy into the low-cost sensor signal when the low-cost sensor signal is converted by the generator GAN_{L→H} into a high-cost sensor signal, and inject Laplacian energy into the high-cost sensor signal when the high-cost sensor signal is converted by the GAN_{H→L} into a low-cost sensor signal. The Laplacian energy is Laplacian energy of a neural network; and the Laplacian energy is used to adjust Laplacian energy of a model in a generative deep learning architecture.

The OTS module is configured to: mine, based on an optimal transport theory, potential correlation between unpaired and weakly paired data, and construct, according to the potential correlation, an optimal mapping between a feature of the low-cost sensor signal and a feature of the high-cost sensor signal.

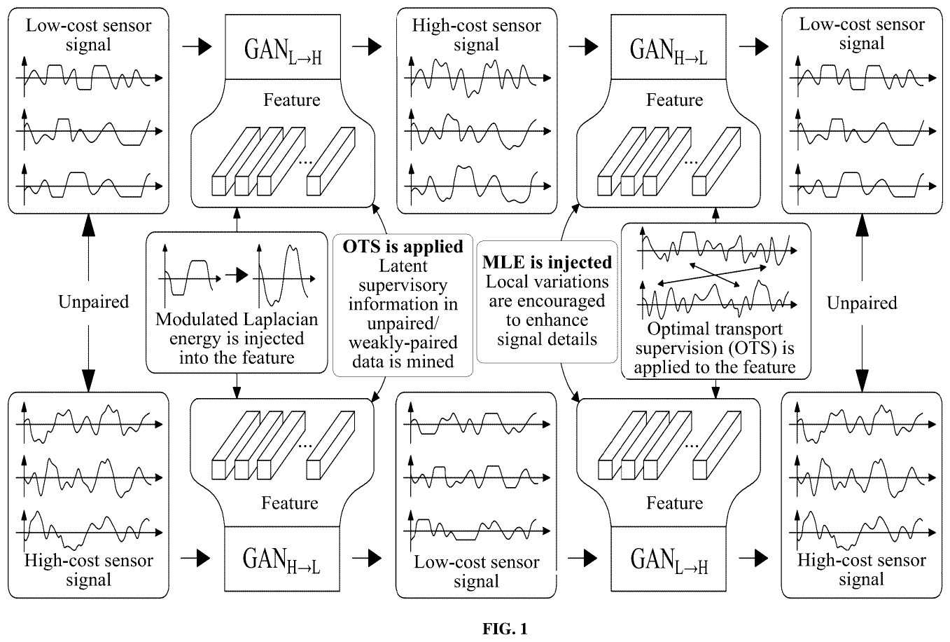

In some embodiments, an overall (bidirectional generative architecture) HEROS-GAN framework is as shown in FIG. 1, and mainly includes two generators. The generator GAN_{L→H} is configured to convert the low-cost sensor signal into a high-cost sensor signal. The generator GAN_{H→L} is configured to map the high-cost sensor signal to the low-cost sensor signal. The design inspiration for this bidirectional generation architecture stems from CycleGAN. However, unlike traditional CycleGAN, HEROS-GAN introduces the OTS and MLE modules during generation and supervision processes to enhance learning capability and generation effect of a model.

The high-cost sensor signal acquired by the signal acquisition module is an unpaired data signal in the inertial sensor. The low-cost sensor signal acquired by the signal acquisition module is an unpaired data signal in the inertial sensor.

In some embodiments, the OTS module includes a transport cost sub-module, a feature alignment sub-module, and an optimal mapping calculation sub-module.

The transport cost sub-module is configured to calculate transport cost between the feature of the low-cost sensor signal and the feature of the high-cost sensor signal. The transport cost is determined based on a similarity between the feature of the low-cost sensor signal and the feature of the high-cost sensor signal.

The feature alignment sub-module is configured to align the feature of the low-cost sensor signal with the feature of the high-cost sensor signal.

The optimal mapping calculation sub-module is configured to, determine, in a state in which the feature of the low-cost sensor signal is aligned with the feature of the high-cost sensor signal, an optimal mapping from the feature of the low-cost sensor signal to the feature of the high-cost sensor signal according to minimal transport cost.

Specifically, the OTS module is configured to extract as much supervisory information as possible from unpaired data and feed the supervisory information back to the generator. Specifically, an optimal mapping between the feature of the low-cost sensor signal and the feature of the high-cost sensor signal is found by the OTS module based on the optimal transport theory, to optimize a difference between the feature of the low-cost sensor signal and the feature of the high-cost sensor signal. This module can be introduced to effectively resolve the lack of supervision in the case of unpaired data, thereby providing a rich training signal for the generator. Local details of the generated signals are enhanced by the MLE module by calculating the Laplacian energy of the feature and performing appropriate energy modulation. This module is particularly crucial in high-dynamic signal generation, as it ensures that the generator captures subtle signal variations without introducing excessive noise, thereby producing signals that are both physically consistent and rich in detail.

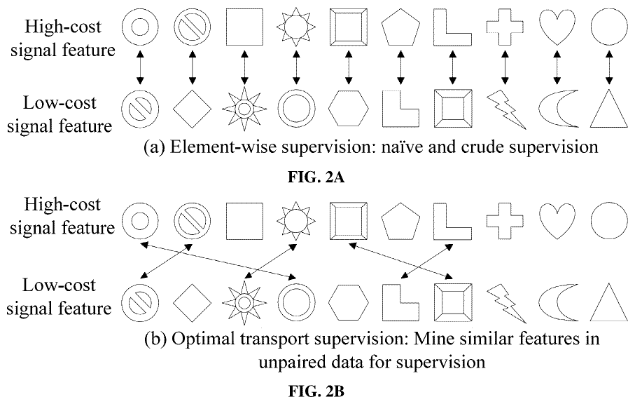

Specifically, a principle of an OTS mechanism is to construct an optimal mapping between the feature of the low-cost sensor signal and the feature of the high-cost sensor signal based on the optimal transport theory, to maximize supervisory information in unpaired data. It is assumed that the feature of the low-cost sensor signal is represented as F_{L}(x_{L})={f_{L1}, f_{L2}, . . . , f_{LN}} [symbol] ^{N×d}, and the feature of the high-cost sensor signal is represented as F_{H}(x_{H})={f_{H1}, f_{H2}, . . . , f_{HN}}∈ [symbol] ^{N×d}. In this case, the goal of the optimal transport problem is to find an optimal mapping for aligning a feature distribution of the low-cost sensor signal with that of the high-cost sensor signal, thereby minimizing the “transport costs” between the two feature distributions, as shown in FIGS. 2A-2B. This problem can be formulated as the following optimization problem:

$${min}_{γ ∈ Γ ( {F}_{L} , {F}_{H} )} {\int }_{X \times Y} c ( {f}_{Li} , {f}_{Hj} ) d γ ( {f}_{Li} , {f}_{Hj} )$$

where, Γ (F_{L}, F_{H}) represents a set of joint distributions linking features F_{L} of low-cost sensor signals and features F_{H} of high-cost sensor signals, and c(f_{Li}, f_{Hj}) is a cost function defined between the features f_{Li} and f_{Hj}. To ensure the rationality of the optimal mapping, a formula for calculating the transport cost in the transport cost sub-module described in this embodiment is as follows:

$$c ( {f}_{Li} , {f}_{Hj} ) = {e}^{1 - {f}_{Li} \cdot {f}_{Hj}}$$

where, f_{Li} represents a feature of the low-cost sensor signal in an i^{th} dimension, f_{Hj} represents a feature of the high-cost sensor signal in a j^{th} dimension, and c(f_{Li}, f_{Hj}) is the transport cost.

The design of the transport cost function takes into account influence of an inner product (namely, similarity) between features: The more similar the features are, the lower the cost. Therefore, an optimal mapping is guided to favor the alignment between similar features.

Due to calculation complexity of the optimal transport problem, the Sinkhorn algorithm is adopted in this embodiment to approximate a solution to the aforementioned optimization cost. Entropy regularization is introduced into the Sinkhorn algorithm, so that a high-quality approximate solution can be obtained within reasonable calculation time. In this embodiment, the Sinkhorn algorithm can be used to obtain an optimal transport mapping T: X→Y from the feature of the low-cost sensor signal to the features of the high-cost sensor signal. The most similar features are allowed to be identified and aligned through the optimal mapping in this embodiment within feature space of the generative model, so that effective supervision for unpaired data is provided. Based on this mapping, this embodiment defines an OTS loss function [symbol] _{OTS} to apply appropriate supervision, encouraging the features of the low-cost sensor signals to align with those of some high-cost sensor signals.

Specifically, a specific supervision mechanism is applied to the feature alignment sub-module; and after the specific supervision mechanism is applied, the OTS loss function specifically includes:

$${ℒ}_{OTS} = {{x}_{L} ∼ {P}_{L} , {x}_{H} ∼ {P}_{H}}_{} [ {‖ {F}_{{G}_{L \to H}} ( {x}_{L} ) - T ( {F}_{H} ( {x}_{H} ) ) ‖}^{2} + {‖ {F}_{{G}_{H \to L}} ( {x}_{H} ) - {T}^{- 1} ( {F}_{L} ( {x}_{L} ) ) ‖}^{2} ]$$

where, P_{L} and P_{H} respectively represent a domain distribution of the low-cost sensor signal and a domain distribution of the high-cost sensor signal, F_{H}(x_{H}) is the feature of the high-cost sensor signal, F_{L}(x_{L}) is the feature of the low-cost sensor signal, and F_{G}_{_{L→H}}(x_{L}) is a virtual high-cost signal feature generated after a low-cost signal x_{L} passes through the generator G_{L→H}, and is compared with a real high-cost signal feature F_{H}(x_{H}), to establish a latent consistency constraint therebetween through the optimal transport mapping T. F_{G}_{_{H→L}}(x_{H}) is a virtual low-cost signal feature generated after a high-cost signal x_{H} passes through the generator G_{H→L}, and is compared with a real low-cost signal feature F_{L}(x_{L}), to establish a latent consistency constraint therebetween through the optimal transport mapping T⁻¹.

By minimizing [symbol] _{OTS}, the generative model is guided to produce low-cost sensor signal features that align as closely as possible with high-cost sensor signal features, thereby achieving signal enhancement.

To ensure effectiveness of the OTS mechanism, this embodiment provides a rigorous mathematical proof of existence of the optimal mapping and demonstrates convergence of the optimal mapping in a training process. In addition, it is further learned in this embodiment that in a traditional GAN architecture, conflicting objectives of a generator and a discriminator often lead to oscillatory and unstable gradient updates. In contrast, oscillations during training are effectively reduced by using the OTS mechanism by exerting fine-grained control over feature space of the generated signals, to ensure that the generator is optimized more stably to obtain an optimal solution. These properties of the OTS mechanism enable effective enhancement of quality of generated signals even in the absence of paired data, playing a key role in the enhancement of low-cost accelerometer signals.

In some embodiments, for the task of enhancing low-cost accelerometer signals, in addition to limitations in signal range, the lack of signal detail is also a critical problem that needs to be resolved. Due to generally low sensitivity, it is difficult for a low-cost sensor to capture a subtle signal variation. This results in generated signals that are relatively smooth and lack necessary details. This phenomenon is particularly obvious in a high-dynamic environment, directly affecting signal reliability and application performance.

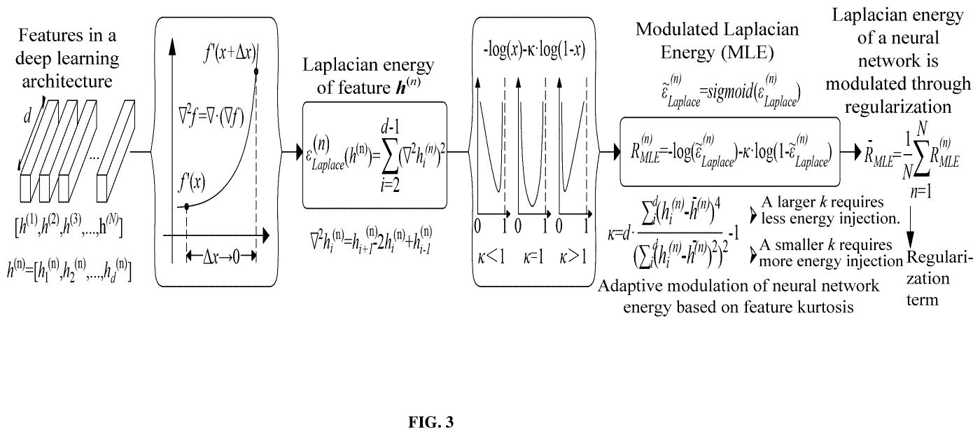

A traditional generative adversarial network (GAN) is effective in generating signals, but often fails to produce signals with rich details. This is because GAN-generated signals tend to be globally smooth while ignoring local subtle variations. To resolve this problem, this embodiment provides a “Modulated Laplacian Energy (MLE)” regularization mechanism, to enhance a detailed expression of signals by modulating local energy of the generated signal features, thereby improving overall signal quality, as shown in FIG. 3.

The core of the MLE mechanism lies in using a Laplacian operator to measure local variations in a feature layer and enhancing these variations through appropriate energy modulation. The Laplacian operator is a second-order differential operator capable of effectively capturing subtle changes and local variations in signals. Specifically, given a feature h⁽ⁿ⁾ (represented as a feature at an n^{th} layer in the neural network, with a dimensionality of d), Laplacian energy

$${E}_{Laplace}^{( n )} ( {h}^{( n )} )$$

for a neural network feature is designed in this embodiment. A calculation formula of the Laplacian energy in the MLE module is as follows:

$${E}_{Laplace}^{( n )} ( {h}^{( n )} ) = {\sum }_{i = 2}^{d - 1} {( {∇}^{2} {h}_{i}^{( n )} )}^{2} ,$$

$$where , {∇}^{2} {h}_{i}^{( n )}$$

is a second-order derivative of a feature

$${h}_{i}^{( n )}$$

in an i^{th} dimension, d is the dimensionality, n is a number of layers, h⁽ⁿ⁾ represents the feature at the n^{th} layer in the neural network, and

$${E}_{Laplace}^{( n )} ( {h}^{( n )} )$$

is the Laplacian energy. The

$${∇}^{2} {h}_{i}^{( n )}$$

is defined as follows:

$${∇}^{2} {h}_{i}^{( n )} = {h}_{i + 1}^{( n )} - 2 {h}_{i}^{( n )} + {h}_{i - 1}^{( n )}$$

$$where , {h}_{i}^{( n )}$$

is a feature at the n^{th} layer at the i^{th} dimension,

$${h}_{i + 1}^{( n )}$$

is a feature at n^{th} layer in a (i+1)^{th} dimension, and

$${h}_{i - 1}^{( n )}$$

is a feature at the n^{th} layer in a (i−1)^{th} dimension.

Herein, higher Laplacian energy indicates stronger variability and more remarkable local changes of the feature. Lower Laplacian energy indicates more smoothness and fewer variations of the feature. Therefore, by modulating the Laplacian energy, the generative network can be guided to enhance local details of the signal in this embodiment, without maintaining smoothness when excessive details are undesirable.

In some embodiments, an energy modulation module is further included in this application, configured to modulate the Laplacian energy based on an energy modulation regularization term.

Specifically, to reasonably modulate the Laplacian energy, an energy modulation regularization term R_{MLE} is designed in this embodiment for dynamically adjusting the Laplacian energy of the feature layer in the generation process. This prevents excessively high energy from causing significant noise or excessively low energy from causing loss of signal details.

The expression of the energy modulation regularization term in the energy modulation module is as follows:

$${R}_{MLE} = - log ( {E}_{Laplace} ) - κ \cdot log ( 1 - {E}_{Laplace} )$$

where, σ is a Sigmoid function, and is used to normalize the Laplacian energy to an interval (0,1), and κ is a modulation parameter. A modulation formula of the modulation parameter κ is specifically as follows: κ

$$κ = d \cdot \frac{{\sum }_{i}^{d} {( {h}_{i}^{( n )} - {\overline{h}}^{( n )} )}^{4}}{{( {\sum }_{i}^{d} {( {h}_{i}^{( n )} - {\overline{h}}^{( n )} )}^{2} )}^{2}} - 1$$

where, d is a dimensionality, n is a number of layers, h⁽ⁿ⁾ represents the feature at the n^{th} layer in the neural network, and h̅⁽ⁿ⁾ is a mean value of

$${h}_{1}^{( n )} , {h}_{2}^{( n )} , … , {h}_{d}^{( n )} , {\overline{h}}^{( n )} = \frac{1}{d} {\sum }_{i = 1}^{d} {h}_{i}^{( n )} .$$

In this embodiment, c is designed as a kurtosis of the feature that is used to measure variability of the feature. A position of a minimum value of the regularization term and an injection degree of the Laplacian energy are determined by using the κ parameter. Specifically, when the feature has strong variability (κ is large), less energy injection is required, and the minimum value of R_{MLE} will occur at a lower Laplacian energy level. On the contrary, when the feature has weak variability (κ is small), more energy injection is required, and the minimum value of R_{MLE} will occur at a higher Laplacian energy level. This adaptive behavior ensures that the MLE mechanism can dynamically adjust energy injection based on the variability of the feature, thereby enhancing signal details in high-dynamic environments while reducing noise in stable conditions.

When the MLE mechanism is constructed, special attention is paid to the mathematical properties of a regularization term in this embodiment. First, R_{MLE} approaches infinity as E_{Laplace} approaches 0 or 1, thereby imposing a strong penalty on extremely low or high Laplacian energy levels and ensuring that the Laplacian energy remains within a moderate range. Then, an amount of energy injected is controlled by using the modulation parameter κ, so that less energy is injected when the variability of the feature is strong, and more energy is injected when the variability of the feature is weak. This adaptive energy modulation mechanism allows the generated signals to exhibit sufficient local details without introducing additional noise due to excessively high energy injection. By minimizing R_{MLE}, the generative network can effectively enhance the local details of the signal while maintaining overall smoothness of the signal, thereby producing more accurate and realistic signals. This mechanism plays a crucial role in enhancing low-cost accelerometer signals, effectively resolving disadvantages of the traditional generative adversarial network in enhancing signal details.

In practical experiments, effectiveness of the MLE mechanism is evaluated through a plurality of datasets and evaluation metrics. The experimental results demonstrate that the HEROS-GAN model using the MLE mechanism is not only significantly better than other methods in terms of signal details, but also exhibits highly reliable physical consistency in the signals. These experimental results confirm the effectiveness of the MLE mechanism in enhancing low-cost accelerometer signals and further establish a leading position of the HEROS-GAN in this field.

In summary, this application has the following beneficial effects:
(1) This application proposes an OTS mechanism to resolve the problem of signal enhancement for low-cost inertial sensor signals under unpaired data conditions. The optimal transport theory is used by the OTS to construct an optimal mapping between the features of low-cost and high-cost sensor signals, to maximize utilization of latent supervisory information from unpaired data. Specifically, the transport cost between features is calculated by the OTS module to guide the generator in achieving optimal alignment of signal features within the feature space. Insufficiency of supervision in the traditional GAN architecture is effectively overcome by using this mechanism under unpaired data conditions, so that learning capability of the generative model and the effectiveness of signal enhancement are remarkably enhanced.
(2) The MLE mechanism in this application is a novel feature-level energy modulation method designed to enhance the local detail representation of generated signals. The Laplacian energy of neural network feature layers is calculated through MLE to capture subtle variations in signals and dynamically regulates energy injection based on feature variability (for example, kurtosis). This adaptive modulation mechanism can not only effectively enhance signal details in high-dynamic environments, but also avoid introducing excessive noise due to over-modulation. Through rigorous mathematical derivation, rationality and stability of Laplacian energy are ensured through MLE, so that physical consistency and realism of generated signals are further improved.
(3) This application proposes a HEROS-GAN that integrates both OTS and MLE mechanisms. The architecture employs two generators (G_{L→H} and G_{H→L}) working collaboratively to achieve a bidirectional mapping between low-cost and high-cost sensor signals. Unlike a traditional CycleGAN, the HEROS-GAN incorporates the OTS module to enhance supervision on unpaired data in the generation process, and utilizes the MLE module to optimize local details of generated signals. This bidirectional design ensures not only global consistency of the generated signals, but also significantly improves reconstruction accuracy and quality of low-cost accelerometer signals through multi-level detail enhancement.
(4) The HEROS-GAN architecture proposed in this application is the first to combine the optimal transport theory with energy modulation mechanisms: OTS and MLE, innovatively resolving the disadvantages of a traditional GAN models in enhancing low-cost sensor signals, such as insufficient supervision and lack of details. The OTS mechanism is used in the solution to extract maximized latent supervisory information and the MLE mechanism is used to achieve precise energy modulation at the feature level, so that both global and local consistency and accuracy of the generated signals are ensured. The uniqueness of this solution lies in its ability to effectively enhance the signal quality of low-cost inertial sensors without relying on frame-wise paired data, so that an economical and efficient solution for a wide range of industrial, medical, and smart device applications is provided.
(5) This application is the first to achieve over-range signal reconstruction for inertial sensors.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of this application. The description of the foregoing examples is used to help illustrate the method of this application and the core principles thereof. In addition, those of ordinary skill in the art can make various modifications in terms of specific implementations and scope of application in accordance with the teachings of this application. In conclusion, the content of the present specification shall not be construed as a limitation to this application.

What is claimed is:

1. An over-range signal restoration and signal quality enhancement system for an inertial sensor, comprising: a generator GAN_{L→H}, a generator GAN_{H→L}, an optimal transport supervision (OTS) module, a modulated Laplacian energy (MLE) module, and a signal acquisition module, wherein
the signal acquisition module is configured to acquire a high-cost sensor signal and a low-cost sensor signal, wherein the low-cost sensor signal and the high-cost sensor signal are unpaired or weakly paired;
the generator GAN_{H→L} is configured to convert the high-cost sensor signal into a low-cost sensor signal;
the generator GAN_{L→H} is configured to convert the low-cost sensor signal into a high-cost sensor signal;
the MLE module is configured to: inject Laplacian energy into the low-cost sensor signal when the low-cost sensor signal is converted by the generator GAN_{L→H} into a high-cost sensor signal, and inject the Laplacian energy into the high-cost sensor signal when the high-cost sensor signal is converted by the GAN_{H→L} into a low-cost sensor signal, wherein the Laplacian energy is Laplacian energy of a neural network, and is used to adjust Laplacian energy of a model in a generative deep learning architecture; and
the OTS module is configured to: mine, based on an optimal transport theory, potential correlation between unpaired and weakly paired data, and construct, according to the potential correlation, an optimal mapping between a feature of the low-cost sensor signal and a feature of the high-cost sensor signal.

2. The over-range signal restoration and signal quality enhancement system for an inertial sensor according to claim 1, wherein a calculation formula of the Laplacian energy in the MLE module is as follows:
$${E}_{Laplace}^{( n )} ( {h}^{( n )} ) = {\sum }_{i = 2}^{d - 1} {( {∇}^{2} {h}_{i}^{( n )} )}^{2}$$
$$wherein , {∇}^{2} {h}_{i}^{( n )}$$
is a second-order derivative of a feature
$${h}_{i}^{( n )}$$
in an i^{th} dimension, d is a dimensionality, n is a number of layers, h⁽ⁿ⁾ represents a feature at an n^{th} layer in the neural network, and
$${E}_{Laplace}^{( n )} ( {h}^{( n )} )$$
is the Laplacian energy.

3. The over-range signal restoration and signal quality enhancement system for an inertial sensor according to claim 1, further comprising: an energy modulation module, configured to modulate the Laplacian energy based on an energy modulation regularization term.

4. The over-range signal restoration and signal quality enhancement system for an inertial sensor according to claim 3, wherein a formula of the energy modulation regularization term in the energy modulation module is as follows:
$${R}_{MLE} = - log ( {E}_{Laplace} ) - κ \cdot log ( 1 - {E}_{Laplace} )$$
$$wherein , {E}_{Laplace} = σ ( ( {\sum }_{i = 2}^{d - 1} {( {∇}^{2} {h}_{i}^{( n )} )}^{2} ) ,$$
σ is a Sigmoid function that is used to normalize the Laplacian energy to an interval (0,1), and κ is a modulation parameter.

5. The over-range signal restoration and signal quality enhancement system for an inertial sensor according to claim 4, wherein a modulation formula of the modulation parameter κ is specifically as follows:
$$κ = d \cdot \frac{{\sum }_{i = 2}^{d - 1} {( {h}_{i}^{( n )} - {\overline{h}}^{( n )} )}^{4}}{{( {\sum }_{i = 2}^{d - 1} {( {h}_{i}^{( n )} - {\overline{h}}^{( n )} )}^{2} )}^{2}} - 1$$
wherein, d is a dimensionality, n is a number of layers, h⁽ⁿ⁾ represents a feature at an n^{th} layer in the neural network, and h̅⁽ⁿ⁾ is a mean value of
$${h}_{1}^{( n )} , {h}_{2}^{( n )} , ⋯ , {h}_{d}^{( n )} .$$

6. The over-range signal restoration and signal quality enhancement system for an inertial sensor according to claim 1, wherein the OTS module comprises a transport cost sub-module, a feature alignment sub-module, and an optimal mapping calculation sub-module, wherein
the transport cost sub-module is configured to calculate transport cost between the feature of the low-cost sensor signal and the feature of the high-cost sensor signal, wherein the transport cost is determined based on a similarity between the feature of the low-cost sensor signal and the feature of the high-cost sensor signal;
the feature alignment sub-module is configured to align the feature of the low-cost sensor signal with the feature of the high-cost sensor signal; and
the optimal mapping calculation sub-module is configured to, determine, in a state in which the feature of the low-cost sensor signal is aligned with the feature of the high-cost sensor signal, an optimal mapping from the feature of the low-cost sensor signal to the feature of the high-cost sensor signal according to minimal transport cost.

7. The over-range signal restoration and signal quality enhancement system for an inertial sensor according to claim 6, wherein a calculation formula of the transport cost in the transport cost sub-module is as follows:
$$c ( {f}_{Li} , {f}_{Hj} ) = {e}^{1 - {f}_{Li} \cdot {f}_{Hj}}$$
wherein, f_{Li} is a feature of the low-cost sensor signal in an i^{th} dimension, f_{Hj} is a feature of the high-cost sensor signal in a j^{th} dimension, and c(f_{Li}, f_{Hj}) is the transport cost.

8. The over-range signal restoration and signal quality enhancement system for an inertial sensor according to claim 7, wherein a specific supervision mechanism is applied to the feature alignment sub-module; and after the specific supervision mechanism is applied, an OTS loss function specifically comprises:
$${ℒ}_{OTS} = {𝔼}_{{x}_{L} ∼ {P}_{L} , {x}_{H} ∼ {P}_{H}} [ {‖ {F}_{{G}_{L \to H}} ( {x}_{L} ) - T ( {F}_{H} ( {x}_{H} ) ) ‖}^{2} + {‖ {F}_{{G}_{H \to L}} ( {x}_{H} ) - {T}^{- 1} ( {F}_{L} ( {x}_{L} ) ) ‖}^{2} ]$$
wherein, P_{L} and P_{H} respectively represent a domain distribution of the low-cost sensor signal and a domain distribution of the high-cost sensor signal, F_{H}(x_{H}) is the feature of the high-cost sensor signal, F_{L}(x_{L}) is the feature of the low-cost sensor signal, F_{G}_{_{L→H}}(x_{L}) is a virtual high-cost signal feature generated after a low-cost signal x_{L} passes through the generator G_{L→H}, F_{G}_{_{H→L}}(x_{H}) is a virtual low-cost signal feature generated after a high-cost signal x_{H} passes through the generator G_{H→L}, and T is an optimal transport mapping.
